(19) United States
(12) Patent Application Publication
(10) Pub. No.: US 2005/0284281 A1
(43) Pub. Date: Dec. 29, 2005

(54) Resonant body structure in string instrument

(76) Inventor: Masahiro Suyama, Hamamatsu-shi (JP)

Correspondence Address: JACOBSON HOLMAN PLLC, 400 SEVENTH STREET N.W., SUITE 600, WASHINGTON, DC, 20004, US

(21) Appl. No.: 11/149,423

(22) Filed: Jun. 10, 2005

(30) Foreign Application Priority Data
Jun. 11, 2004 (JP) 2004-174511

(51) Int. Cl. G10D 3/02

(52) U.S. Cl. 84/294

(57) ABSTRACT

The present invention intends to provide a musical instrument that is improved in the acoustic performance, expanded in the capability of sound expressions in musical performance and suitable for kinds of string instruments more than existing solid guitars, solid base guitars and other string instruments. In a string instrument that generates musical sounds based on a vibration of a string stretched over a resonant body, the resonant body is formed on a basis of three-layer structure made of a top plate, a back plate and an intermediate plate interposed between the top plate and back plate, the top plate and back plate each being made of a single panel that is cut so that a woodgrain direction is a plate surface direction, the intermediate plate that is cut so as to come into contact with the top plate and back plate at end grain being laminated with the top plate and back plate at the end grain, and thereby a resonant body structure is constituted.

### BACKGROUND OF THE INVENTION

1. Field of the Invention

The present invention relates to a multi-layer structure that constitutes a resonant body of a string instrument.

2. Description of the Related Art

In a string instrument such as a guitar, plywood has been used as a constitution material of a resonant body. It can be said that the selection thereof is made to cope with an increase in the cost owing to the starvation of a wood resource that becomes a raw material and is not based on the acoustical superiority thereof. In particular in an electric guitar that has a resonant body called a solid, in a type in which an entirety of a resonant body is coated with a coating film containing a pigment, in comparison with a type where a resonant body is coated with a clear lacquer or the like, woodgrain does not stand out; accordingly, there is a situation in that the plywood can be conveniently used. Furthermore, a structure of a plywood or laminated timber is under study. For instance, JP-A No. 08-72025 discloses as a wooden plate material and a manufacturing method thereof a configuration in which at least two kinds of wooden chips each having a ground color different from each other are laminated and adhered in an end grain direction and/or in a terminal direction. However, the invention just intends to obtain, while taking advantage of the stately feeling and texture that wood materials have, a pattern abundant in colors and variation.

On the other hand, JP-A No. 2004-58416 discloses an invention relating to a manufacturing method of a wood material for musical instruments and a wood material for musical instruments obtained by the manufacturing method. The invention has a configuration that includes; a first laminating in which a plurality of wood single panels is coated with or immersed in a resin, laminated with a fiber direction arranged constant, followed by thermocompression bonding to obtain a laminated body; and a second laminating in which an obtained laminated body is sliced at a constant angle to a direction perpendicular to a laminated surface along a direction of fiber to obtain laminated single panels, obtained laminated single panels are coated with or immersed in a resin, laminated with a fiber direction arranged constant followed by thermocompression bonding to obtain a second laminated body; and in the first and/or second laminating, the density of the laminated body is controlled in the range of 0.8 to 1.4 g/cm³. The density of 0.8 g/cm³ is one of hard and heavy woods such as oaks or the like and the density of 1.4 g/cm³ is comparable to that of coal. The invention intends to provide a wood material for musical instruments, which has the vibration characteristics very similar to natural wood materials for musical instruments such as granadilla and rose wood that are used in clarinets or the like, and to obtain such advantages that the sound quality of manufactured musical instruments is excellent, the difference between individual instruments is slight, the lead time is short, the yield is improved and the degree of freedom in appearance design is large.

Thus, inventions of wood materials for musical instruments, which have been proposed so far, can be said that these inventions have been carried out in view of the preservation of natural wood species, that is, with an intention of developing alternative materials therefor. Since the object thereof is to provide only alternative materials, it is not necessarily developed from the relationship with structure/function that a musical instrument should have. In this meaning, the foregoing inventions are developments of simple replacement of raw materials or replacement materials. By contrast, the inventors of the present invention have carried out a study and development based on an idea that a wood material for musical instruments, which has a plywood structure or a laminated material structure, should be compatible as far as possible with the acoustic characteristics of a musical instrument to which the material is applied, and came to the invention.
Patent literature 1: JP-A No. 08-72025
Patent literature 2: JP-A No. 2004-58416

### SUMMARY OF THE INVENTION

The present invention was carried out in view of the above situations and has an object of improving the acoustic characteristics more than string instruments like an existing solid guitar, solid base guitar or the like and thereby of expanding the capability in the musical expression from a viewpoint of performance. Furthermore, another object of the invention is to provide a resonant body structure that can have the acoustic performance suitable for kinds of string instruments.

In order to overcome the above-mentioned problems, in the invention, in a string instrument that generates musical sounds based on vibrations of a string stretched over a resonant body, the resonant body is formed on a basis of a three-layer structure made of a top plate, a back plate and an intermediate plate interposed between the top plate and the back plate, the top and back plates each being made of a single panel that is cut so that a woodgrain direction may be a plate surface direction, the intermediate plate being cut so as to come into contact with the top plate and the back plate at an end grain and laminated with the top plate and the back plate at the end grain (FIG. 1).

A resonant body structure of a string instrument according to the invention is a unit for generating musical sounds based on vibrations of a string. The transmission speed of the vibration transmitted to a wood material varies depending on structures of wood tissues. It is known that there is a difference of substantially 4:1 between a transmission speed in a direction along a woodgrain and that in a direction intersecting with the woodgrain, that is, the vibration transmitted in a direction along a woodgrain is transmitted at a speed faster by substantially four times than the vibration transmitted in a direction intersecting with the direction of the woodgrain.

On the other hand, a string vibration is transmitted from a top surface of a resonant body to a back surface thereof. That is, in the beginning, when a string is picked a vibration owing to the string is transmitted through a bridge and a pickup to a top surface of the resonant body and further through an intermediate portion of the resonant body to a back surface. Thereafter, the vibration reached the back surface is reflected and once more goes through the intermediate portion to reach the top surface. These are repeated. From these, since a material structure is uniform in an existing resonant body, it is considered that the transmission speed of the vibrations transmitted between the top surface and back surface is solely determined by quality of material.

In this connection, in the invention, a resonant body structure 10 is formed on a three-layer structure basis made of a top plate 11, a back plate 12 and an intermediate plate 13 interposed between the top plate 11 and the back plate 12. The top and back plates each are cut so that a woodgrain direction may be a plate surface direction, and between these an intermediate plate that is cut so that an end grain may come into contact with the top plate and the back plate is sandwiched (FIGS. 2 and 3). The top plate and the back plate each are made of a single panel. The single panel means not to be a plywood; however, there is no problem to be a laminated wood. Laminating thin wood sheets with an adhesive makes plywood, and woodgrain directions of sheets of adjacent layers are intersected at a right angle to each other. Laminating at least two wood materials with an adhesive makes a laminated wood material, and woodgrain directions of all wood materials are substantially in parallel.

The top plate and the back plate constituting a resonant body can be dealt with in three ways of a case where woodgrain directions are in coincidence, a case where woodgrain directions are perpendicular to each other or a case where woodgrain directions are different from both. Furthermore, the top plate and the back plate can be dealt with in three ways of a case where woodgrain directions are directed in a longitudinal direction (or a longitudinal direction of a neck) of the resonant body, a case where woodgrain directions are perpendicular to the longitudinal direction or a case where woodgrain directions are different from both. One in an example shown in FIGS. 2 and 3 corresponds to a resonant body structure in which woodgrain directions of the top and back plates are coincident. In the resonant body structure according to the invention, as each of the top plate and back plate that are formed of a single plate, a laminated wood can be used, and in the intermediate plate mill ends called chips or end grain material, which come into contact with the top plate and the back plate at the grain end and have been frequently discarded can be used. Accordingly, the invention contributes as well to the effective utilization of wood resources.

FIG. 1 shows names of various portions of wood sections and cuttings of wood. In many cases, wood is cut so that a woodgrain direction described as flat grain or straight grain may appear on a material surface. Accordingly, useless mill ends that are not used as timber are generated. In the invention, the mill ends can be used as the intermediate plate. In the invention, the resonant body is formed on a three-layer structure basis including the top plate, the back plate and the intermediate plate. However, since by superposing two pairs of three-layer structures with a back plate or top plate sharing a resonant body having a five-layer structure can be formed, a structure having three layers or more can be taken.

Since the invention is constituted and operates as mentioned above, a vibration input transmitted based on the vibration of the string is acoustically processed by a resonant body structure formed on a three-layer structure basis including the top plate, the back plate and the intermediate plate sandwiched therebetween. Accordingly, advantages such that 1) a leading-edge of sound, that is the response thereof, becomes excellent, 2) the sound is not confined but clearly comes out on a surface, that is, excellent in so-called forward-expansion, 3) the echo becomes longer (sustainment becomes longer), and 4) a dynamic range is expanded, the acoustic performance is improved and the capability of musical expressions can be expanded can be obtained. Accordingly, when the invention is applied to a string instrument such as a solid guitar, the acoustic performance suitable for these can be provided.

### BRIEF DESCRIPTION OF THE DRAWINGS

FIG. 1 is an explanatory view describing names and cuttings of various portions of sections for explaining a wood material that is used in a resonant body structure according to the invention.

FIG. 2 is an exploded perspective view showing an example of a wood structure constituting the resonant body structure according to the invention.

FIG. 3 is a perspective view showing an example of a resonant body structure similarly according to the invention.

FIG. 4 is a perspective view showing an example of a resonant body structure for a solid guitar similarly according to the invention.

FIG. 5 is a perspective view showing an example of a resonant body structure for a solid base guitar similarly according to the invention.

FIG. 6 is a perspective view showing an example of a resonant body structure for a solid archtop guitar similarly according to the invention.

FIG. 7 is a perspective view showing an example of a resonant body structure for a solid guitar similarly according to the invention.

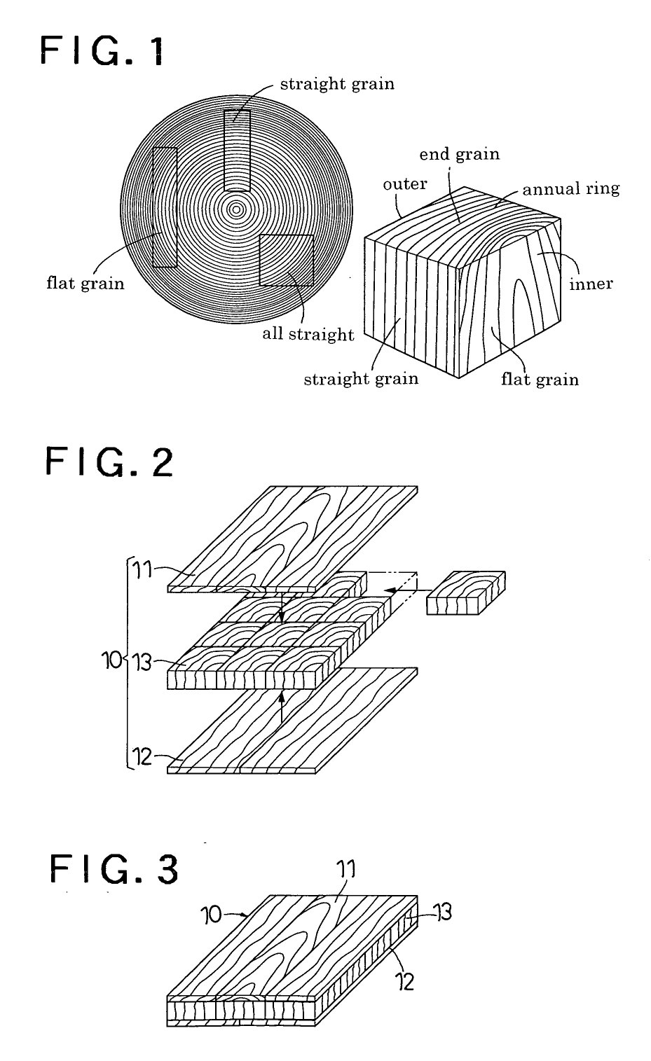

### DESCRIPTION OF THE PREFERRED EMBODIMENTS

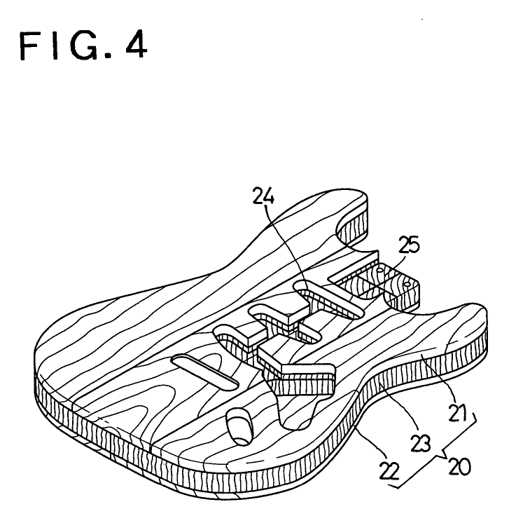

In what follows, the present invention will be detailed with reference to embodiments shown in the drawings. FIG. 4 is an exemplification of a resonant body structure 20 of a solid guitar. The resonant body has a top plate 21, a back plate 22 and an intermediate plate 23 interposed therebetween, the top plate 21 and back plate 22 each being made of a single plate (the “single plate” as used in this invention includes those made of a solid board, a laminated board, a particle board and the like), with woodgrain directions thereof arranged in the same direction, end grains of the intermediate plate 23 being brought into contact with the top plate 21 and back plate 22 and adhered thereto with an adhesive, the grain directions of the top plate 21 and back plate 22 being directed in a length direction of the resonant body. In constituent materials of the resonant body structure 20, the top plate 21 is thicker than the back plate 22, and the intermediate plate 23 is further thicker than the top plate 21. On a top plate side of the resonant body structure 20, several recesses 24 that penetrate the top plate 21 and intermediate plate 23 and end at the back plate 22 are formed for attaching bridges and pickups.

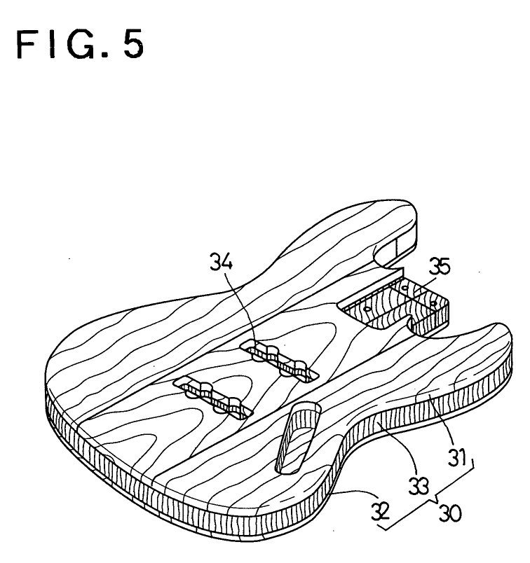

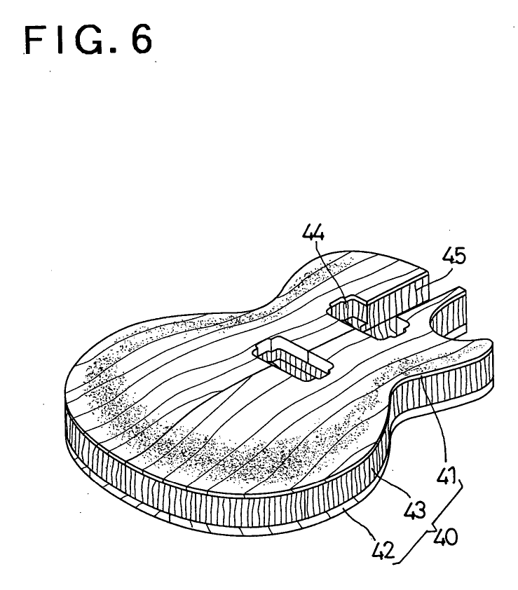

FIG. 5 shows an example of a resonant body structure 30 of a solid base guitar. In the solid base guitar, a top plate 31, a back plate 32 and an intermediate plate 33 are, similarly to an example shown in the FIG. 4, cut and adhered into one body to form a three-layer structure. Furthermore, on a top plate side a plurality of recesses 34 is disposed with the same purpose. FIG. 6 shows an example of a resonant body structure 40 of an archtop guitar. In the archtop guitar, a top plate 41, a back plate 42 and an intermediate plate 43 that are cut similarly to the above are adhered into one body to form a three-layer structure. In examples shown in FIGS. 5 and 6, thicknesses and directions of woodgrain of the top plates 31 and 41, back plates 32 and 42 and intermediate plates 33 and 43 are same as the case shown in FIG. 4.

The resonant body structures 20, 30 and 40 having a three-layer structure shown in each of FIGS. 3, 4 and 5 are considered that portions of the intermediate plates 23, 33 and 43 made of the end grain material exhibit a resonant effect similar to a hollow portion in an acoustic guitar. Furthermore, in the resonant body structures 20, 30 and 40, neck attachment grooves 25, 35 and 45, in examples shown in FIGS. 4 and 5, are formed to a depth in the middle of the intermediate plates 23 and 33, and in an example shown in FIG. 6, are formed to a depth near the back plate. The attachment grooves 25, 35 and 45 each are one of transmission ports that transmit a vibration of a string to bridges, pickups and also to the resonant body structures 20, 30 and 40.

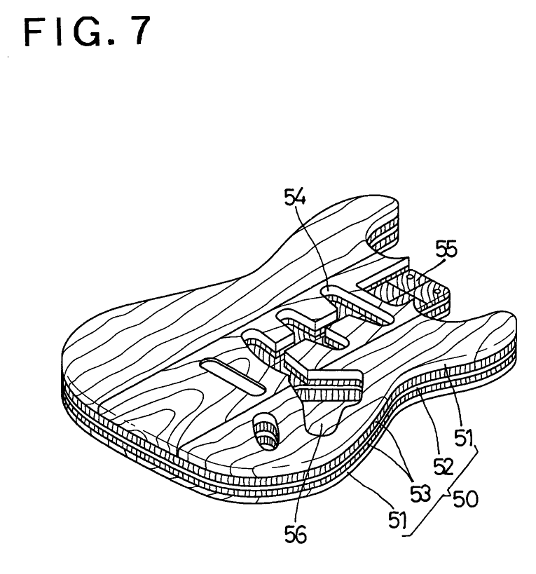

FIG. 7 shows an example of a resonant body structure 50 in which two pairs of three-layer structures having a top plate 51, a back plate 52 and an intermediate plate 53 are stacked sharing the plate 52 that is a back plate, and thereby a five-layer structure is formed. In the example, recesses 54 for bridges or the like are stopped at a depth up to an upper intermediate plate 53, and separately therefrom a hollow 56 for attaching an electronic component is disposed so as to end at a lower top plate 51. A reference numeral 55 denotes a neck attachment groove.

In what follows, Examples 1 through 7 in which kinds of wood materials and thicknesses of plates are varied from each other will be described. Regarding the wood material, alder and basswood are used for the top plate and back plate, and alder, basswood and matoa are used for the intermediate plate. Tests are carried out to evaluate an influence of the density on the tone quality. The density is largest in matoa, followed by alder, and further followed by basswood. Examples 1 through 7 and evaluation results thereof are summarized in a separate table.

### EXAMPLE 1

A plate thickness of a top plate is set at 11.5 mm, that of a back plate is set at 7 mm, and that of an intermediate plate is set at 26.5 mm, alder having the medium density was used for the top plate and back plate and basswood having small density was used for the intermediate plate. These were adhered under pressure by use of a wood adhesive into an integrated resonant body structure having a three-layer structure shown in FIG. 4. This was formed, painted and necessary components were attached thereto, and thereby a solid guitar having a thickness of 45 mm was prepared.

### EXAMPLE 2

Thicknesses of a top plate, a back plate and an intermediate plate were set same as that of Example 1, on the other hand, regarding the wood material basswood of small density was used for all plates, and according to a manner same as Example 1 a solid guitar shown in FIG. 4 was prepared.

### EXAMPLE 3

Thicknesses of a top plate, a back plate and an intermediate plate were set same as that of Example 1, on the other hand, regarding wood material alder of medium density was used for all plates, and according to a manner same as Example 1 a solid guitar shown in FIG. 4 was prepared.

### EXAMPLE 4

Thicknesses of a top plate and a back plate were set same at 11.5 mm, that of an intermediate plate was set at 22 mm, regarding wood material alder was used for the top plate and back plate and matoa of large density was used for the intermediate plate, and according to a manner same as Example 1 a solid guitar having a thickness of 45 mm shown in FIG. 4 was prepared.

### EXAMPLE 5

Thicknesses of a top plate and a back plate, respectively, were set at 11.5 mm and 7 mm same as that of Example 3, that of an intermediate plate was set at 23.5 mm substantially 10 and several percent less than that of Example 3, regarding wood material alder same as Example 3 was used, and according to a manner similar to Example 1 a solid base guitar shown in FIG. 5 and having a thickness of 42 mm was prepared.

### EXAMPLE 6

By use of a top plate having a thickness of 11.5 mm, a top side intermediate plate having a thickness of 10.5 mm, a center back plate having a thickness of 5.5 mm, a back side intermediate plate having a thickness of 10.5 mm, and a back plate having a thickness of 7.0 mm and alder for all plates, a solid guitar having a five-layered structure same as FIG. 7 and a thickness of 45 mm was prepared.

### EXAMPLE 7

By use of a top side intermediate plate having a thickness of 9.5 mm, a back side intermediate plate having a thickness of 9.5 mm, and a center back plate having a thickness of 4.5 mm, all reduced by 1 mm from that in Example 6, and other plates having thicknesses same as Example 6, and alder for all plates, a solid guitar having a five-layer structure same as FIG. 7 and a thickness of 42 mm was prepared.

<Evaluation>

It was confirmed that Examples 1 and 2 where basswood low in the density was used for the intermediate plate were, in comparison with an existing solid guitar, remarkably improved in four points of the build-up of sound, sustainment, clearness of sound and the dynamic range. In Example 3 where denser alder material is used, the above four points are further improved more than Examples 1 and 2, and Example 4 where the densest matoa material is used results in the best result among all examples. A solid base guitar according to Example 4, which has a three-layer structure, is excellent as well. Furthermore, Examples 6 and 7 having a five-layer structure are obviously improved in comparison with existing solid guitar and solid base guitar; however, other three-layer structures are higher in the performance. When Examples 1 through 5 are evaluated in five grades wherein the acoustic performance of one having the best quality is assigned to 5 and one having high quality among existing solid guitars is assigned to 3, all are evaluated 4 or more. From these, it can be said that when wood material large in the density is used as an intermediate material, the acoustic performance can be largely improved.

TABLE

| | | | | Intermediate | | | |
|---|---|---|---|---|---|---|---|
| Example | | Evaluation | Top plate | plate | Back plate | | |
| 1 | Guitar | 4 | Alder | Basswood | Alder | | |
| | 45 mm | | 11.5 | 26.5 | 7 | | |
| 2 | | 4 | Basswood | Basswood | Basswood | | |
| | | | 11.5 | 26.5 | 7 | | |
| 3 | | 4+ | Alder | Alder | Alder | | |
| | | | 11.5 | 26.5 | 7 | | |
| 4 | | 5 | Alder | Matoa | Alder | | |
| | | | 11.5 | 22 | 11.5 | | |
| 5 | Base | 4+ | Alder | Alder | Alder | | |
| | 42 mm | | 11.5 | 23.5 | 7 | | |
| 6 | Guitar | 4− | Alder | Alder | Center back | Intermediate | Back plate |
| | 45 mm | | | | plate Alder | plate Alder | Alder |
| | | | 11.5 | 10.5 | 5.5 | 10.5 | 7 |
| 7 | Base | 4− | Alder | Alder | Alder | Alder | Alder |
| | 42 mm | | 11.5 | 9.5 | 4.5 | 9.5 | 7 |

Density
Basswood 0.41
Alder 0.43
Matoa 0.61

What are described in the above table are examples and performance evaluations when basswood, alder and matoa are used. Kinds of wood materials that can be used can further include maple, ash, mahogany or the like. Among these, examples that use ash exhibited extremely excellent acoustic performances. However, since experimental results are slight, examples that use the ash are not included as examples. However, wood materials such as the maple are considered useful as an intermediate material from the density. Other than these, many wood materials for musical instruments including walnut, rose wood or the like can be used. Since string instruments such as the solid guitars are substantially constant in shape and dimension and, from an external dimension of a resonant body thereof, optimum dimensions of the respective plate thicknesses of the top plate, back plate and intermediate plate can be determined. Numerical values shown in the separate table can be used also for this purpose. According to the numerical values, the minimum thickness of the top plate is substantially 7 mm and that of the back plate is similarly substantially 7 mm, in the case of the thickness being less than the value, in the top plate, when parts are attached, the strength in the screw mounting becomes deficient, and both the top plate and back plate become difficult to inhibit from cracking or warping. Furthermore, it is already explained that in order to obtain desired acoustic performances the material quality of the intermediate plate, in particular, the large density thereof is important; however, in the case of the three-layer structure, the intermediate plate preferably has a thickness more than substantially one third a total thickness. When the plate thickness of the intermediate plate is deficient, the acoustic advantages according to the invention may be insufficient.

1. A resonant body structure comprising, in a string instrument that generates a musical sound based on a vibration of a string stretched over a resonant body, a resonant body formed on a basis of a three-layer structure made of a top plate, a back plate and an intermediate plate interposed between the top plate and the back plate, wherein the top plate and the back plate each are made of a single plate cut so that a woodgrain direction is in a plate surface direction, and the intermediate plate is cut so as to come into contact with the top plate and the back plate at an end grain and laminated to the top plate and the back plate at the end grain.

2. The resonant body structure according to claim 1, wherein in the resonant body, woodgrain directions of the top plate and the back plate coincide with each other and are directed in a longitudinal direction of the resonant body.

3. The resonant body structure according to claim 1, wherein two pairs of three-layer structures each of which is made of the top plate, the back plate and the intermediate plate are laminated with the top plate or the back plate shared and thereby form a five-layer structure.

4. The resonant body structure according to claim 1, wherein in the three-layer structure the intermediate plate has a thickness substantially one third or more a total thickness.
